(19) United States
(12) Patent Application Publication
(10) Pub. No.: US 2007/0085464 A1
(43) Pub. Date: Apr. 19, 2007

(54) Suspension system of a frame/mask assembly for colour cathode ray tubes

(75) Inventors: Roberto Tetti, Colleferro (Roma) (IT); Antonio Ragona, Roma (IT); Antonio Zegretti, Segni (Roma) (IT); Alberto Cacciotti, Colleferro (Roma) (IT)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: Thomson Licensing

(21) Appl. No.: 11/581,023

(22) Filed: Oct. 13, 2006

(30) Foreign Application Priority Data
Oct. 14, 2005 (IT) 05/A001949

(51) Int. Cl. H01J 29/80

(52) U.S. Cl. 313/402; 313/406

(57) ABSTRACT

Color cathode ray tube comprising a glass front face on which a screen of luminescent materials is deposited as well as a frame/color selection mask assembly, the mask being maintained by welding on the frame, the frame/mask assembly being suspended within the tube by means of support means, at least one of the support means integrates a metal part forming a spring and comprising an aperture at one of its extremities into which fits a metal pin inserted in the glass front face of the tube, and at its other extremity an aperture to enable it to be attached to the frame either by a rivet or by a screw/nut assembly. This type of attachment provides an additional degree of liberty in positioning the aperture of the spring designed to cooperate with the pin of the front face.

The invention relates to a colour cathode ray tube and more particularly to the suspension system of the colour selection frame/mask assembly arranges within the glass envelope of the tube. The invention finds its application in any type of tube comprising a colour selection mask and is also well adapted to tubes with a mask that is maintained in tension by the frame with which it is integral as with tubes whose mask is formed by pressing a metal sheet.

### BACKGROUND OF THE INVENTION

The cathode ray tubes comprise a colour selection mask located at a precise distance from the glass front face of the tube, front face on which red, green and blue luminophore networks are laid. Under the influence of three electronic beams each corresponding to a determined primary colour, the luminophore networks enable pictures to be reproduced on the screen, the mask enabling each determined beam to illuminate only the luminophore of the corresponding colour.

The colour selection mask must be arranged and maintained in a specific position within the said tube during the manufacture, then during the operation of the tube. The support functions are realised owing to a generally very rigid rectangular metal frame on which the mask is conventionally welded. The frame/mask assembly is mounted in the front face of the tube by suspension means comprising at least three metal parts welded to the frame, each of the said parts comprising one extremity forming a spring and pierced with an aperture, which fits around one of the metal pins included in the glass front face. The springs must be sufficiently rigid to support the weight of the frame/mask assembly, which can reach several kilos for the large tubes. Two arrangements of suspension means are conventionally used: either at the level of the middle of the sides of the frame, or at the level of the corners of this frame. Large screen tubes have suspensions preferentially arranged in the corners, this arrangement having the advantage of offering better mechanical rigidity guaranteeing that the initial adjustment of the mask/frame distance will not be modified during manufacturing stages of the tube and that the finished tube will offer a better guarantee against implosion.

The frame/mask assembly must be able to be disassembled and accurately reassembled several times during the various stages of the tube manufacturing process, by compression of the suspension springs to release them from the metal pins included in the glass of the front face, without it being necessary to adjust the distance of the mask from the screen again.

The large dimension frames comprising four suspension springs arranged either on the sides of the frame, or in the corners of this frame. The springs are welded on the frame with a certain tolerance then the frame/mask assembly is installed in the front face of the tube. So that the apertures of each spring can fit around each metal pin included in the peripheral flange of the front face of the tube, the apertures of the springs must be in line with the said pins. To resolve the problems of positioning arising from the tolerances allowed in the position of the pins and the apertures of the springs, it is common to use three identical springs having an aperture with a determined diameter, adapted to be positioned accurately on the tapered pin, and one spring having an aperture with a diameter greater than the previous diameter. The frame is then fitted to the front face with no mechanical constraints, the largest aperture absorbing the different tolerances. To prevent any mechanical play of the frame with respect to the pins, a washer of a diameter equal to the diameter of the apertures of the three identical springs is then inserted on the pin and welded onto the fourth spring.

However, it has been noted that this manufacturing process shows too great a dispersion in the positioning of the mask with respect to the screen, dispersion due to the phase of welding the washer to the spring, in which the irregular movements of the parts in relation to each other can act in such a manner that the final position of the washer is not the nominal position. The result is that an entire area of the mask is no longer in the optimum position of the initial adjustment, which can lead to a costly recycling of the frame/mask assembly.

### SUMMARY OF THE INVENTION

The suspension system of a frame/mask assembly according to the invention enables the positioning of this assembly in the front face of the cathode ray tube without having the disadvantages of the prior art. For this, the colour cathode ray tube according to the invention comprises a glass front face on which a screen of luminescent materials is deposited, a colour selection mask arranged in proximity to the screen, a frame with which the mask is integral, the said frame being of a noticeably rectangular form, the frame/mask assembly being maintained within the front face by support means cooperating with the noticeably tapered pins fixed in the thickness of the front face, at least one of the support means integrating a metal part forming a spring and comprising an aperture around which the metal pins fit, the spring comprising a flat extremity, the said spring being characterized in that the said spring is attached to the frame/mask assembly by attachment means, the said means comprising at least one pin linked to the frame and crossing an aperture made at the extremity of the spring, the said pin comprising an extremity larger than the diameter of the said aperture.

### BRIEF DESCRIPTION OF THE DRAWINGS

The invention and its advantages will be better understood from the following description and drawings, wherein:

FIG. 1 is a partially exploded view of a cathode ray tube

FIG. 2 shows suspension means according to the prior art

FIG. 3 illustrates an embodiment of a suspension spring according to the invention

FIG. 4 illustrates a cross-section of an embodiment of a suspension according to the invention

FIG. 5 illustrates a cross-section of an alternative embodiment.

FIG. 6 shows suspension means according to a third embodiment.

FIG. 7 shows another embodiment of the invention detailing a fitted spring by a partial view.

### DESCRIPTION OF PREFERRED EMBODIMENT

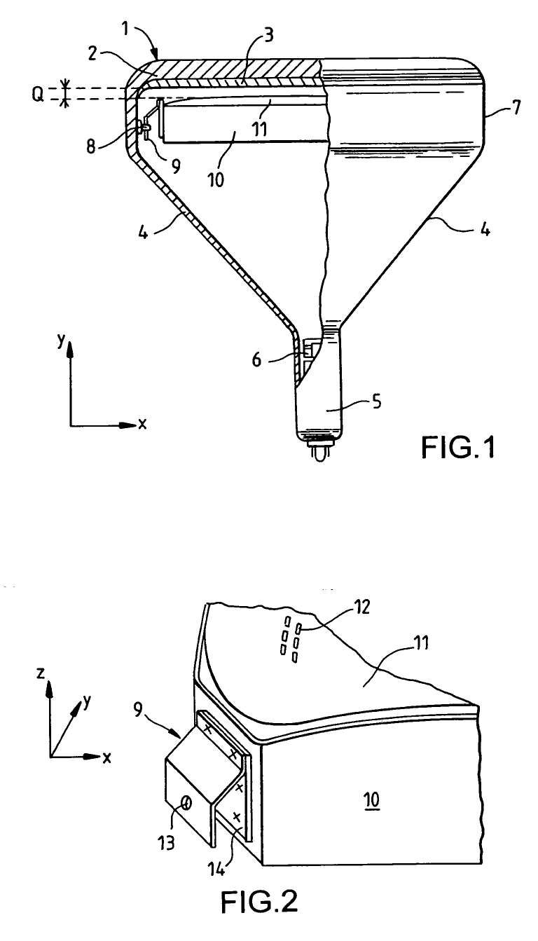

A colour cathode ray tube 1, as illustrated by FIGS. 1 and 2, comprises a glass envelope with three distinct parts, the front face 2 within which is arranged a screen 3 made of a luminescent material, the rear 4 in the form of a funnel and the collar 5 noticeably cylindrical and surrounding the electron gun 6 generating three electron beams in the direction of the screen.

A colour selection mask 11 pierced by apertures or slots 12 is arranged in the tube on the trajectories of the electron beams, between the screen 3 and the gun 6. The mask 11 is welded to a rigid frame 10 maintained in position in the front face of the tube by suspension means comprising metal pins 8 embedded in the peripheral glass flange 7 of the front face and springs 9 comprising an extremity welded either directly on the frame, or at the extremity of a plate whose other extremity is welded to the frame, the springs 9 comprising a second extremity having an aperture 13 designed to cooperate with one of the said pins 8.

The mask must be arranged at a very specific distance from the screen to enable the finished tube to operate correctly, that is mainly that each of the beams illuminates the luminophores of the relevant primary colour. This distance measured in the direction of the main Z-axis of the tube, is known under the name of “Q distance”.

The support means of the frame/mask assembly in the front face must also guarantee the positioning of the mask with respect to the screen during the different manufacturing stages of the tube, stages conventionally requiring the said assembly of the said front face to be removed and reinserted several times.

As illustrated in FIG. 1, the Q distance is adjusted by precisely positioning, through welding to the frame, the springs 9 and thus their aperture 13 by taking into account the distance of the metal pins 8 from the screen. The pins are embedded in the glass of the front face during the manufacture of the said face by the glass worker, and must all be positioned on the same plane parallel to the surface of the screen.

Until now, the dispersions in the positioning of the metal pins, which could be found in different planes, meant using a spring with an aperture of diameter larger than the diameters of the other springs so as to compensate for these dispersions. Hence, the apertures of the three identical springs define the positioning of the surface of the mask in relation to the surface of the luminescent screen and the aperture of the fourth spring guarantees the mechanical stability of the assembly. For this, a washer was first placed by an operator on the pin before inserting the spring then the spring/washer assembly was welded together to immobilise the frame while preventing any mechanical play. However, it was realised that the position of the mask in the direction of the main Z-axis could experience significant dispersions mainly due to two factors:
the position of the washer at the moment of welding may not have been optimum, the washer being able to be inserted at an oblique position onto the pin.
the welding machine may modify the Z position of the spring at the moment of welding, thus locally modifying the Q distance.

The invention takes its origin in the fact the manufacturers of the front panel can control the position of the pins 8 more accurately than in the past, and particularly the position in the direction the Z-axis. The modelling and experiments have shown that the frame/mask system can allow a tolerance of the Q value in the order of 0.25 mm, a tolerance that can be met during the manufacture of the front face for the positioning of the pins.

However, the manufacturers of glass panels can only guarantee a positioning in the XY plane, perpendicular to the Z-axis, to a tolerance in the order of 0.5 mm at best.

The invention enables, without intervening in the production line as in the past, suspension springs to be used, having identical apertures to cooperate with the pins of the glass panel. To achieve this, one of the springs is not fixed by welding to the frame but by attachment means enabling a movement of at least 0.5 mm in the XY plane of the aperture of the spring.

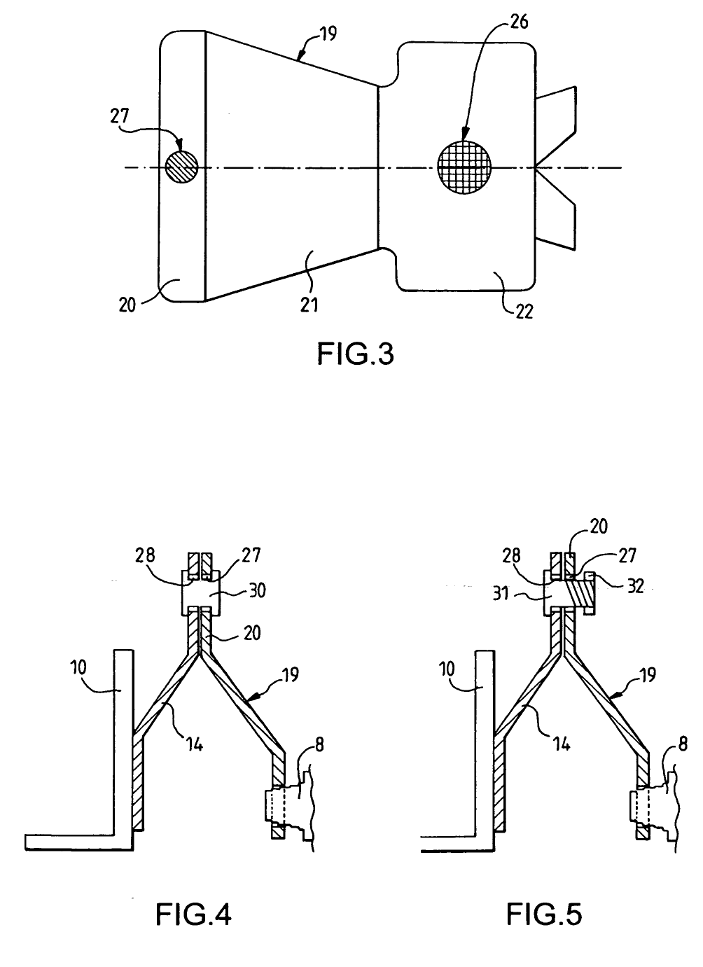

The result is that the form of the suspension springs can be modified in relation to the prior art. FIG. 3 illustrates an embodiment of a spring 19 according to the invention, designed to support the frame/mask from suspension means arranged in the comers of the front panel. The spring is generally constituted by a metal plate comprising, by folding, a first extremity 20 designed to be integral for example by welding to an intermediate plate 14 of the frame 10, a second extremity 22 designed to extend in a direction noticeably parallel to the main Z-axis of the tube and a link portion 21 between both extremities. The extremity 22 comprises a noticeably circular aperture 26. The dimension of the aperture 26 is noticeably identical to the apertures of the other springs designed to fit around and be positioned on the tapered surface of the pins 8. The noticeably flat extremity 20 comprises an aperture 27; the part of the frame on which the spring 19 must be attached comprises an aperture 28 designed to be arranged opposite the aperture 27 of the spring as illustrated by FIGS. 3 and 4. The spring is then attached to the frame with a rivet 30 passing through apertures 27 and 28. The rivet enables the spring to be attached to the frame/mask assembly while offering an additional degree of freedom in the position of the aperture with respect to the said frame/mask assembly, by the pivoting of the spring 19 around the pin that the rivet 30 represents. The surfaces of the frame and the spring pressing against each other are preferentially flat contact surfaces to provide a good mechanical performance of the attachment of the spring to the frame.

A single spring of the type of spring described above can be used to provide the suspension of the frame in the tube, three standard suspension springs 9 being able to provide the suspension in the three other corners of the frame.

In an alternative embodiment described by FIG. 5, the support of the contact surfaces of the spring 19 and the frame one against the other is realized by a screw 31, nut 32 assembly, the screw 31 passing through the aperture 27 of the flat extremity of the spring 19 and the aperture 28 of the extremity of the plate 14 integral with the frame 10.

In an embodiment not shown, the screw 31 is replaced by a cylindrical lug for example integral with the extremity of the plate 14, the said lug having its free extremity threaded in such a manner as to cooperate with a nut to attach the spring 19 against the plate 14 when the lug passes through the aperture 27 of the spring. Alternatively, the lug described above can be integral with the spring 19 and fit through an aperture 28 of the frame to cooperate with an attachment nut.

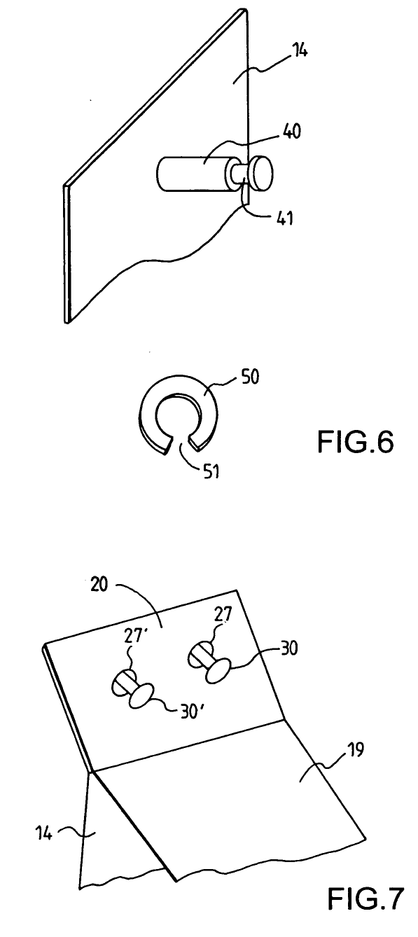

In another embodiment, illustrated by FIG. 6, the intermediate plate 14 comprises a cylindrical lug 40 comprising a groove 41; the lug 40 is designed to pass through the aperture 27 of the spring 19 and a split washer 50 cooperates with the lug 40 to hold the contact surface against the plate 14. To provide the support, the split washer 50 is for example realised in the form of a flat ring whose aperture 51 allows it to be inserted into the groove 41 of the lug.

In another embodiment illustrated by FIG. 7, the spring 19 includes at its extremity attached to the frame/mask system, a first pair of apertures 27 and 27′ separated by around 1.5 cm. The frame/mask assembly also comprises a second pair of apertures arranged opposite the apertures of the spring so as to be able to provide the-attachment of the spring to the frame with two rivets passing through the said aperture pairs. To be able to cover the positioning tolerance of the pins, the rivets must have a body diameter noticeably smaller than the diameters of the apertures (27, 27′) of the spring; it is desirable that the said rivet body has a diameter of the apertures 27, 27′ of at least two times the tolerance to cover, that is 1 mm in the case of a tolerance of 0.5 mm.

The fact of using two rivets enables a better mechanical support of the frame/mask assembly to be obtained and to prevent, when only one spring is used, too great a rotation of the said spring during the manufacturing phases of the tube that would make automatic insertions of the frame/mask assembly into the front face of the tube impossible.

To minimise the number of parts used in the manufacture of the cathode ray tubes the springs 9, 19 can be identical. Hence, three springs comprising at least one aperture at their extremity fixed to the frame can be welded to the frame, and the said aperture for the fourth spring can be used in order to attach it to the frame by a rivet or a screw/nut assembly.

The embodiments described in the example are not restrictive and the invention can just as well be implemented for frame/mask suspension means arranged in the middle of the sides of the frame.

1/ Color cathode ray tube comprising a glass front face on which a screen of luminescent materials is deposited, a color selection mask arranged in proximity to the screen, a frame with which the mask is integral, the said frame being of a noticeably rectangular form, the frame/mask assembly being maintained within the front face by support means cooperating with the noticeably tapered pins fixed in the thickness of the front face, at least one of the support means integrating a metal part forming a spring and comprising an aperture around which one of the metal pins fit, the spring comprising a flat extremity,
wherein the said spring is attached to the frame/mask assembly by attachment means, the said means comprising at least one pin linked to the frame and crossing an aperture made at the extremity of the spring, the said pin comprising an extremity larger than the diameter of the said aperture.

2/ Cathode ray tube according to the aforementioned claim, comprising three other support means, each one comprising a metal part forming a spring and of which one extremity is attached to the frame/mask assembly by welding.

3/ Cathode ray tube according to claim 1, wherein the attachment means comprise an aperture on the flat extremity of the spring, arranged opposite an aperture arranged on the frame/mask assembly and a rivet passing through the spring and the frame/mask assembly by the said two apertures.

4/ Cathode ray tube according to claim 1, wherein the attachment means comprise an aperture on the flat extremity of the spring, arranged opposite an aperture arranged on the frame/mask assembly, in a screw passing through the spring and the frame/mask assembly by the said two apertures and in a nut cooperating with the threaded extremity of the screw.

5/ Cathode ray tube according to claim 1, wherein the frame/mask assembly comprises at least one plate of which one extremity is welded to the frame and a noticeably flat second extremity is a attached to the flat surface of the spring.

6/ Cathode ray tube according to claim 1, wherein the attachment means comprises a lug integral with the frame, the said lug cooperating with an aperture arranged at the level of the flat extremity of the spring.

7/ Cathode ray tube according to the aforementioned claim, wherein the extremity of the lug is threaded, the said extremity cooperating with a nut to maintain the flat part of the spring against the frame/mask assembly.

8/ Cathode ray tube according to claim 6, wherein the lug comprises, at its extremity, a groove cooperating with a split washer to maintain the flat part of the spring against the frame/mask assembly.

9/ Cathode ray tube according to claim 1, wherein the attachment means comprise a first aperture pair on the flat extremity of the spring, arranged opposite a second aperture pair arranged on the frame/mask assembly and two rivets passing through the spring and the frame/mask assembly by the said two aperture pairs.
